(19) United States
(12) Patent Application Publication
(10) Pub. No.: US 2017/0309073 A1
(43) Pub. Date: Oct. 26, 2017

(54) System and method for enabling synchronous and asynchronous decision making in augmented reality and virtual augmented reality environments enabling guided tours of shared design alternatives

(71) Applicant: 30 60 90 Corporation, Seattle, WA (US)

(72) Inventors: John SanGiovanni, Seattle, US (US); Sean B House, Seattle, WA (US); Ethan Lincoln, Seattle, WA (US); John Adam Szofran, US, WA (US)

(21) Appl. No.: 15/396,590

(22) Filed: Dec. 31, 2016

Related U.S. Application Data
(63) Continuation of application No. 15/134,326, filed on Apr. 20, 2016.

(51) Int. Cl. G06T 19/00; H04N 13/00; G06F 3/01; G06T 7/20; H04N 13/04; G09G 5/00

(52) U.S. Cl. CPC G06T 19/006; H04N 13/0497; H04N 13/0051; G09G 5/006; G06F 3/012; G06T 7/20; G06F 3/013; G09G 2370/16

(57) ABSTRACT

The invention disclosed herein provides systems and methods for simplifying augmented reality or virtual augmented reality based communication collaboration, and decision making through a streamlined user interface framework that enables both synchronous and asynchronous interactions in immersive environments.

### CROSS-REFERENCES TO RELATED APPLICATIONS

This application claims the benefit of U.S. application Ser. No. 15/216,981, filed on Jul. 22, 2016 and U.S. application Ser. No. 15/134,326, filed on Apr. 29, 2016, which are both incorporated by reference in its entirety herein for all purposes.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BRIEF DESCRIPTION OF INVENTION

Embodiments include system and method for simplifying augmented reality or virtual augmented realty (together or separately “VAR”) based communication and collaboration enhancing decision making by allowing a plurality of users to collaborate on multiple-dimensional data sets through a streamlined user interface framework that enables both synchronous and asynchronous interactions in immersive environments.

### DESCRIPTION OF THE SEVERAL VIEWS OF THE DRAWINGS

Other features and advantages of the present invention will become apparent in the following detailed descriptions of the preferred embodiment with reference to the accompanying drawings, of which:

FIG. 1 is a flow chart showing an embodiment of the invention;

FIG. 1A is a flow chart showing an embodiment of the invention;

FIG. 1B is a flow chart showing an embodiment of the invention;

FIG. 1C is a flow chart showing an embodiment of the invention;

FIG. 1D is a flow chart showing an embodiment of the invention;

FIG. 1E is a flow chart showing an embodiment of the invention;

FIG. 2 is an environmental view showing movement through a semantic scene or sourced image from a starting area to at least one focus area;

FIG. 3 shows an exemplary semantic scene or sourced image published to a mobile device;

FIG. 4 shows an exemplary graphical representation of a survey;

FIG. 5 is a flow chart showing an embodiment of the invention;

FIG. 6 is an exemplary representation of photosphere relationships;

FIG. 6A is an exemplary representation of design variations;

FIG. 6B is an exemplary representation of alternative viewpoint variation;

FIG. 6C is an exemplary representation of time variations;

FIG. 6D is an exemplary representation of scale variations;

FIG. 6E is an exemplary representation of text variations;

FIG. 6F is an exemplary representation of texture variations;

FIG. 6G is an exemplary representation of walking pattern variation;

FIG. 7 is an exemplary representation of base layer extraction;

FIG. 7A is an exemplary representation of transmission;

FIG. 8 is an exemplary representation of base layer extraction;

FIG. 8A is an exemplary representation of transmission;

FIG. 9A is an exemplary representations of teleporter management;

FIG. 9B is an exemplary representations of teleporter management;

FIG. 9C is an exemplary representations of teleporter management;

FIG. 9D is an exemplary representations of teleporter management;

FIG. 9E is an exemplary representations of teleporter management;

FIG. 9F is an exemplary representations of teleporter management;

FIG. 9G is an exemplary representations of teleporter management;

FIG. 9H is an exemplary representations of teleporter management;

FIG. 9I is an exemplary representations of teleporter management;

FIG. 9J is an exemplary representations of teleporter management;

FIG. 9K is an exemplary representations of teleporter management;

FIG. 9L is an exemplary representations of teleporter management;

FIG. 10 is an exemplary representation of a semantic scene or sourced image;

FIG. 11A is an environmental representation showing a user interacting content in an immersive environment; and

FIG. 11B is an environmental representation showing a user interacting with content in an immersive environment.

### DETAILED DESCRIPTION OF THE INVENTION

In the following detailed description, reference is made to the accompanying drawings, which form a part hereof. In the drawings, the use of similar or the same symbols in different drawings typically indicates similar or identical items, unless context dictates otherwise.

The illustrative embodiments described in the detailed description, drawings, and claims are not meant to be limiting. Other embodiments may be utilized, and other changes may be made, without departing from the spirit or scope of the subject matter presented here.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of the more general classes. In general, use of any specific exemplar is intended to be representative of its class, and the non-inclusion of specific components (e.g., operations), devices, and objects should not be taken as limiting.

The present application uses formal outline headings for clarity of presentation. However, it is to be understood that the outline headings are for presentation purposes, and that different types of subject matter may be discussed throughout the application (e.g., device(s)/structure(s) may be described under process(es)/operations heading(s) and/or process(es)/operations may be discussed under structure(s)/process(es) headings; and/or descriptions of single topics may span two or more topic headings). Hence, the use of the formal outline headings is not intended to be in any way limiting. Given by way of overview, illustrative embodiments include systems and methods for improving VAR based communication and collaboration that enhances decision making allowing a plurality of users to collaborate on multiple-dimension data sets through a streamlined user interface framework that enables both synchronous and asynchronous interactions in immersive environments.

To reduce potential confusion, the following glossary provides general definitions of several frequently used terms within these specifications and claims with a view toward aiding in the comprehension of such terms. The definitions that follow should be regarded as providing accurate, but not exhaustive, meanings of the terms. Italicized words represent terms that are defined elsewhere in the glossary.

Sourced image is an image that represents a three-dimensional environment or data-set. A sourced image may also be used as a variation.

Semantic scene is a sourced image that is layered with at least one description, teleporter, hotspot, annotation or combination thereof.

Scene is a locus, or vantage point, that represents a location in space which is visible to a user.

Hotspot is a point within a semantic scene or sourced image with which a user may interact. The hotspot may allow a user to view multiple aspects of a scene and/or respond to a survey.

Teleporter is a point within a scene that allows a user to navigate to another scene or another location within the same scene.

Variation is a modification of a semantic scene and/or sourced image.

Publisher creates a semantic scene or a sourced image that is published to a user in an immersive environment. A user may also be a publisher, content creator, author, and/or project owner.

Description may be text, sound, image, or other descriptive information.

Meeting is defined by more than one user interacting with a scene or semantic scene on an immersive platform.

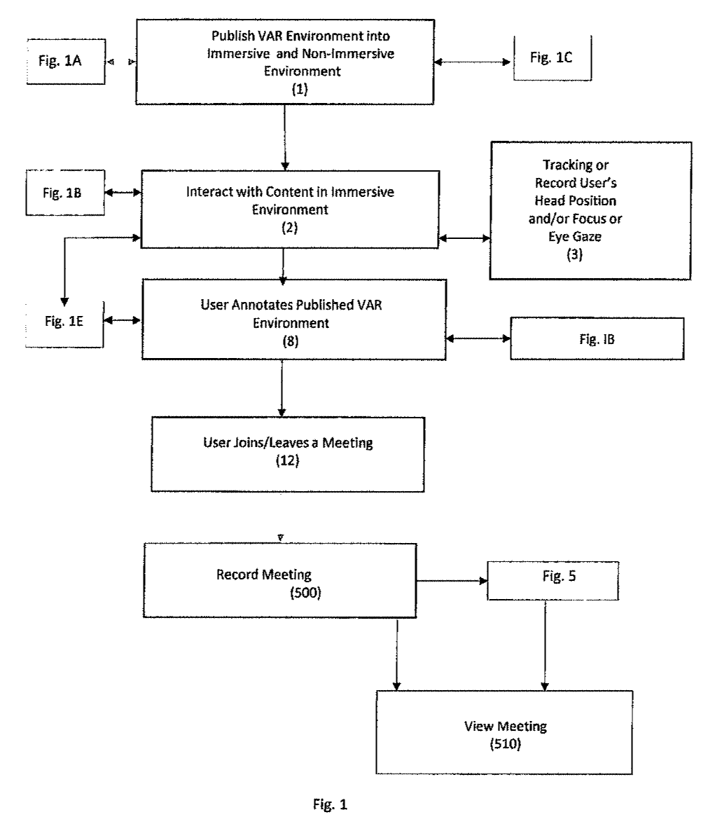

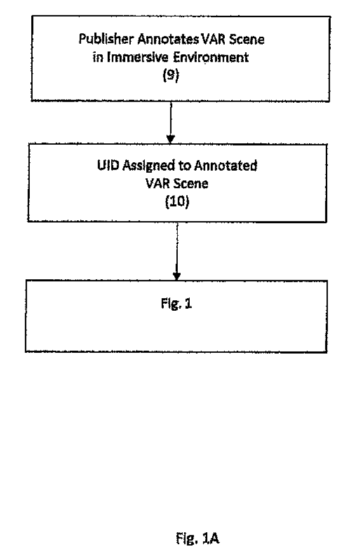

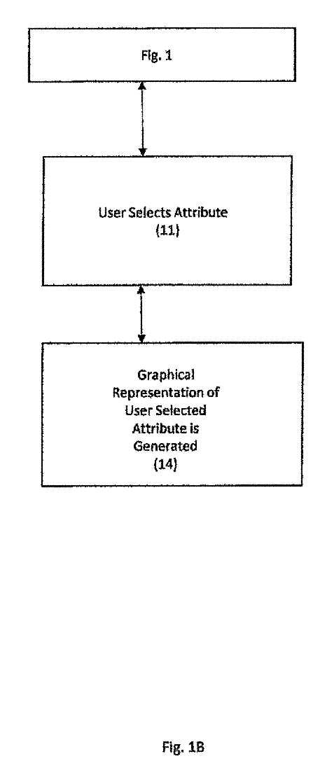

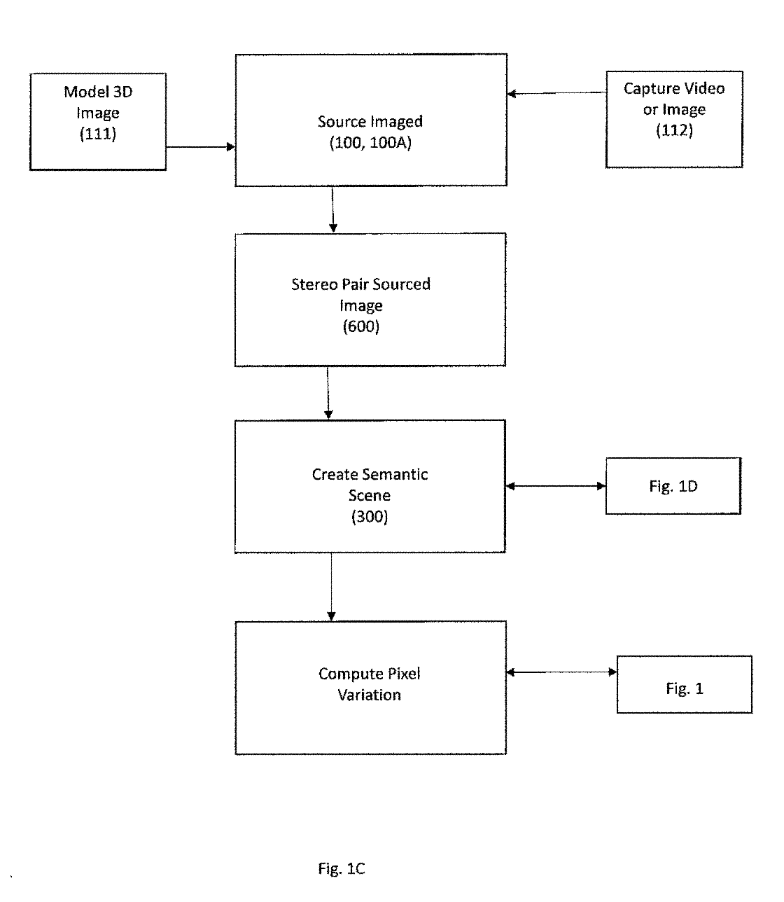

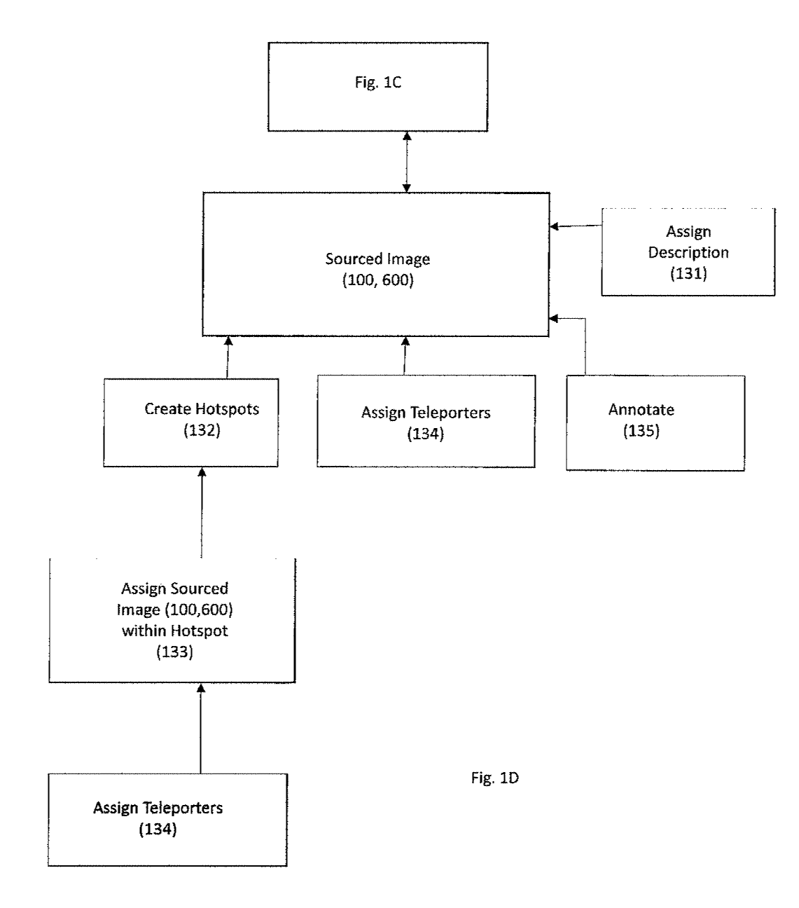

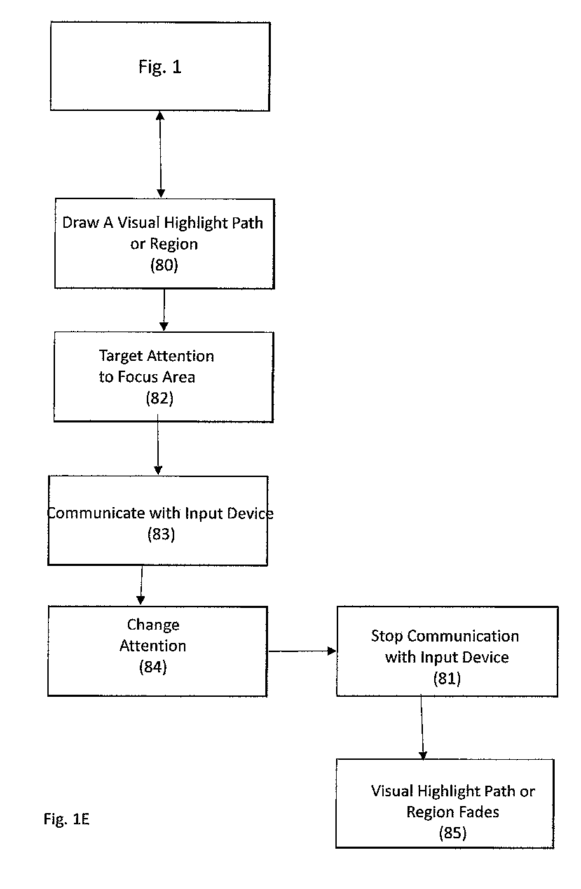

Referring to FIG. 1, according to an embodiment, immersive content is published into a VAR immersive or non-immersive interactive environment (1). According to an embodiment, a user may interact with the published VAR content in the interactive immersive environment (2). According to an embodiment, a plurality of users may interact with VAR content in an interactive environment, synchronously or asynchronously, on an immersive application (2). According to an embodiment, the immersive environmental application may be web based or mobile based, or a tethered or untethered dedicated VAR hardware.

According to an embodiment, a user may annotate published VAR content in an interactive environment on an immersive or non-immersive environmental application (8). According to an embodiment, more than one user may annotate VAR content in an interactive environment, synchronously or asynchronously, on an immersive or non-immersive environmental application (8). According to an embodiment, an immersive or non-immersive environmental application may be a web based or mobile based, or a tethered or untethered dedicated VAR hardware.

Referring to FIGS. 1 and 1C, according to an embodiment, a publisher may generate a semantic scene (300) on a web or mobile platform prior to publication. According to an embodiment, at least one image is a sourced image (100) to generate a semantic scene (300). A sourced image (100) may be a variation (100A) or a combination thereof.

Referring to FIG. 1C, according to an embodiment, a sourced image (100) may be an image or video captured using a smart phone, tablet, or 360 capture devices (112), for example. According to an embodiment, a sourced image (100) may be modeled using three-dimensional design tools (111). According to an embodiment, a sourced image (100) may be an image or video captured using a smart phone, tablet, or 360 capture devices (112), for example; a three-dimensional model; or a combination thereof (111). Three-dimensional modeling tools may include Rhino, Sketchup, 3dsMax, AutoCAD, Revit, or Maya, amongst others.

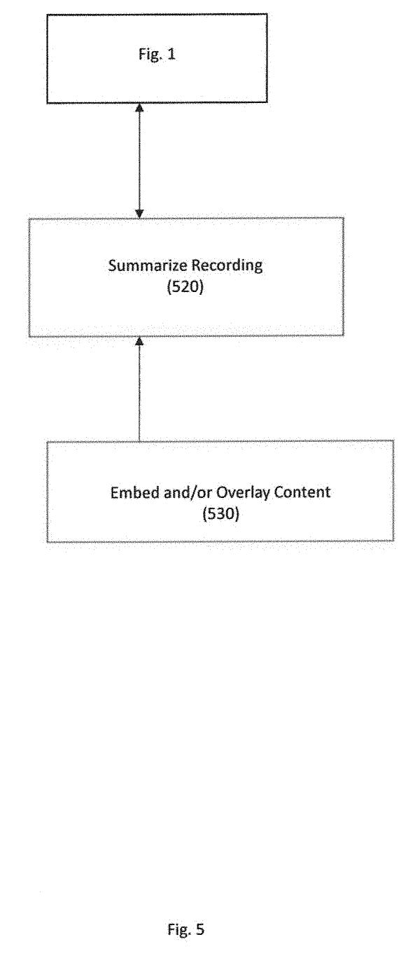

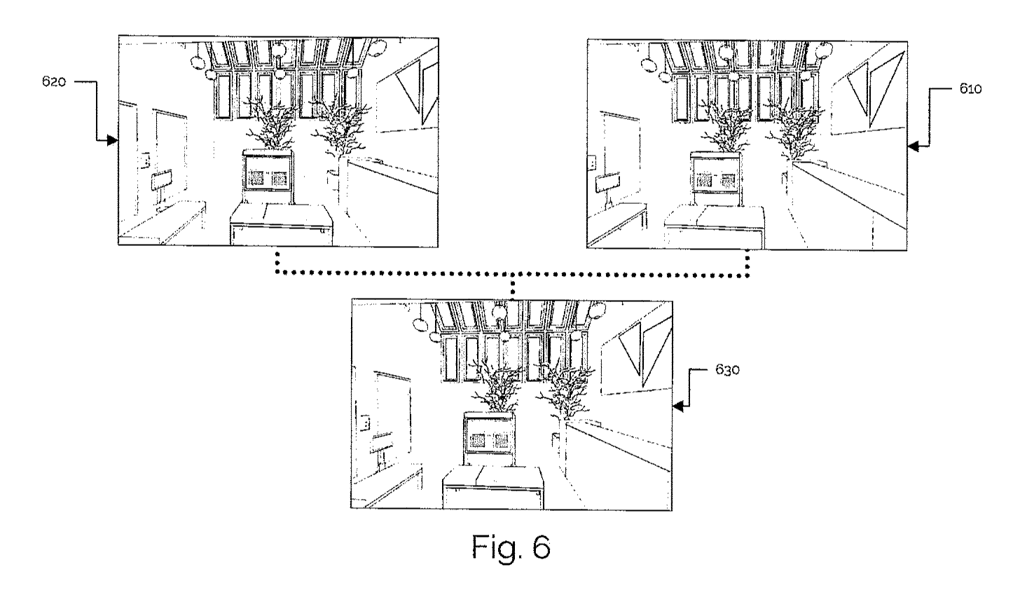

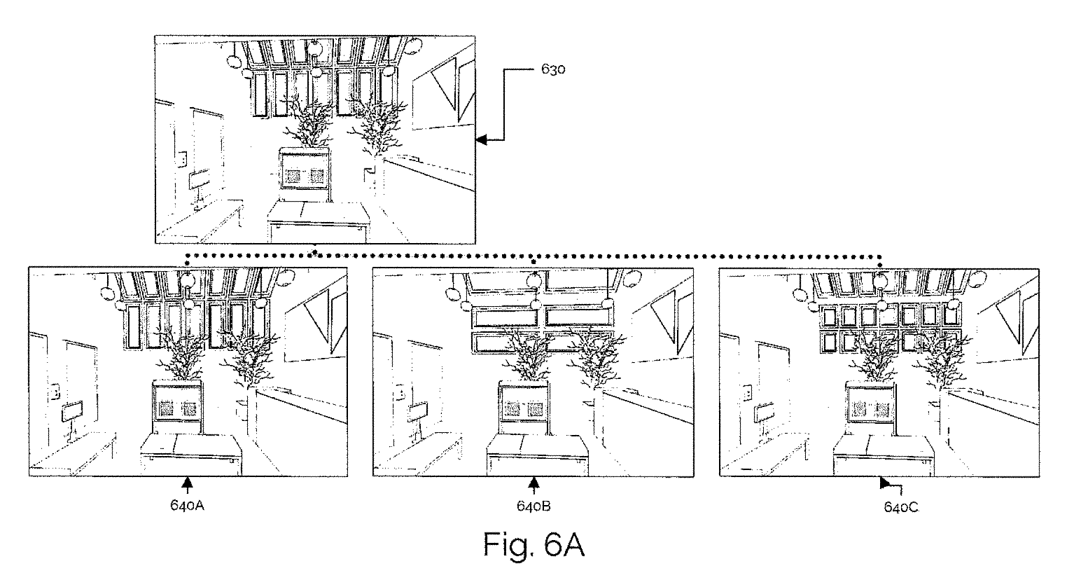

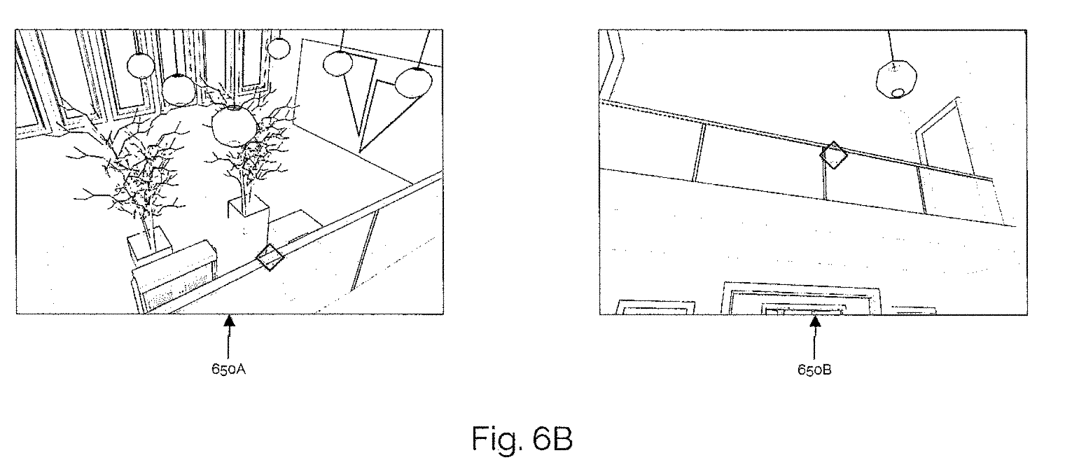

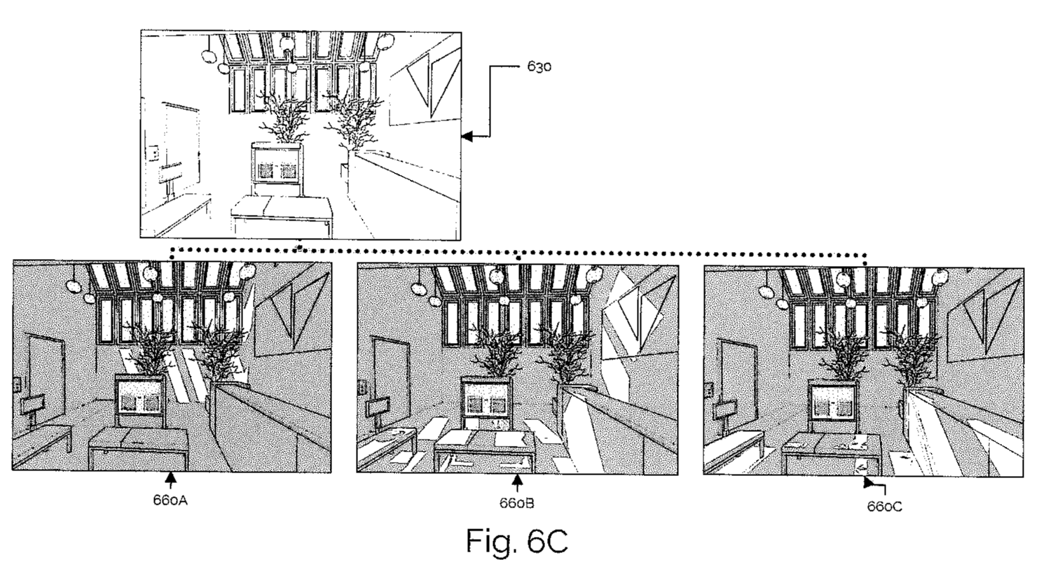

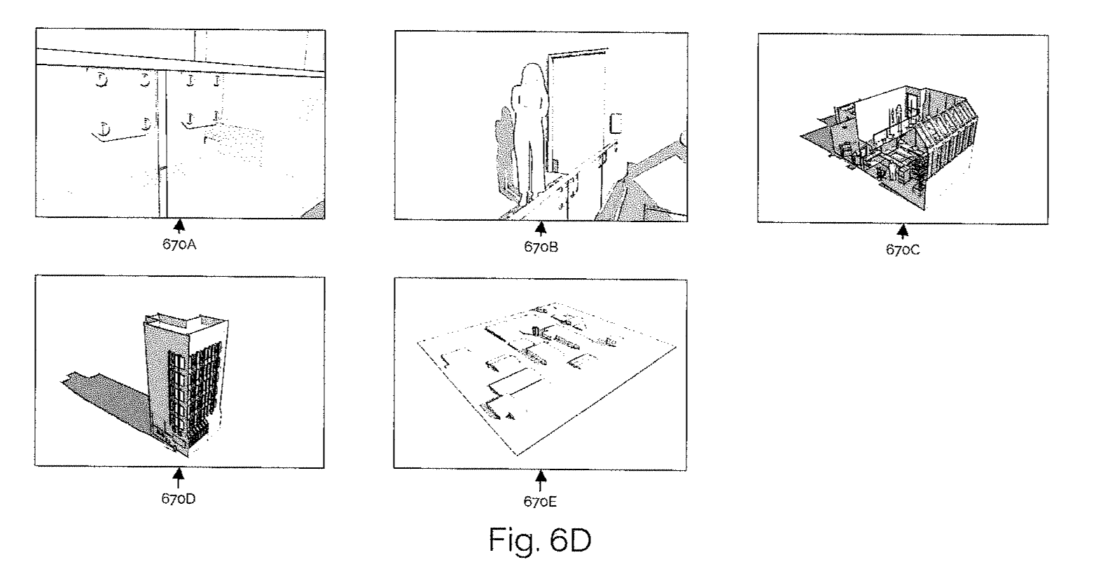

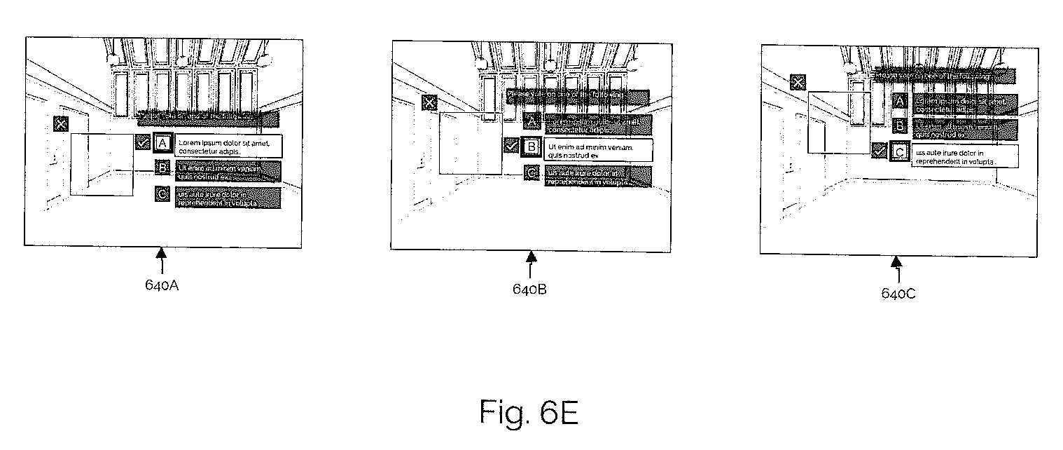

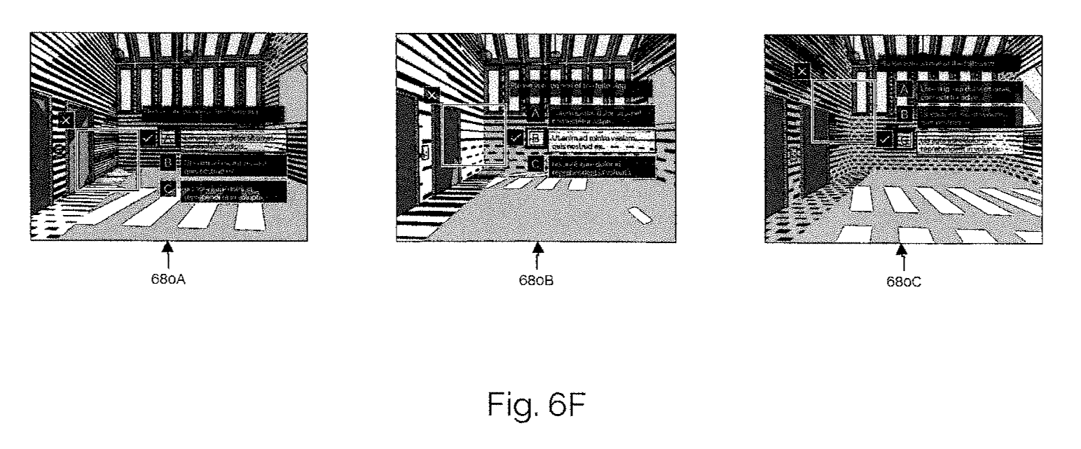

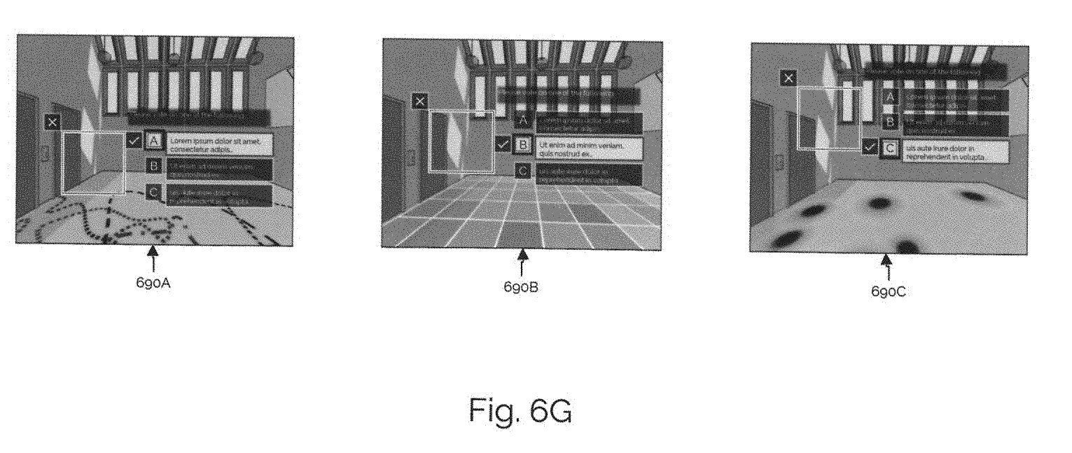

Referring to FIGS. 1C and 6, according to an embodiment, the sourced image (100) may be received as a spherical environmental map, a cubic environmental map, a high dynamic range image (“HDRI”) map, or a combination thereof. (600) According to an embodiment, environmental maps are used to create left (620) and right (610) stereo paired images. According to an embodiment, a panoramic image may be created. According to an embodiment, interactive parallax images may be created. According to an embodiment, an environmental map establishes the appearance, spatial relationship, and time relationship of an image. According to an embodiment, appearance may include pixel values.

Referring to FIG. 6A, according to an embodiment, a variation (100A) may be a design variation. For exemplary purposes, a sourced image (630) may have design variations (640A, 640B, 640C) related to the overhead window layout.

Referring to FIGS. 6 and 6B, according to an embodiment, a variation (100A) may be a point of view. For exemplary purposes, a sourced image (630) may have an exterior vantage point of view (650A) and an interior vantage point of view (650B).

Referring to FIG. 6C, according to an embodiment, a variation (100A) may be a data overlay which creates a change in the appearance of an image. According to an embodiment, a sourced image (630) may include a data overlay that shows various points in time at which the sourced image (630) is viewed. For example, a point in time may include early morning (660A), in the afternoon (660B), and in the evening (660C). Referring to FIGS. 6 and 6E, according to an embodiment, data overlay may include text. For example, a sourced image (630) may show overlays with varied text; e.g., text A (680A), text B (680B), text C (680C).

Referring for FIGS. 6 and 6F, according to an embodiment, a sourced image may include a data overlay that may describe temperature variations. For example, a sourced image (630) may show overlays describing temperature variation A (680A), temperature variation B (680B), temperature variation C (680C). Referring to FIGS. 6 and 6G, according to an embodiment, a sourced image (100) may have at least one overlay showing various walking patterns. For exemplary purposes, a sourced image (630) may have at least one overlay that shows walking pattern A (690A), walking pattern B (690B), walking pattern C (690C).

Referring to FIG. 6D, a sourced image (100) may have various points. According to an embodiment, a point of view may include changed scale, perspective, or vantage point. For exemplary purposes, a sourced image (100) may have a point of view that may be a detail scale (670A), human scale (670B), floor scale (670C), single floor scale (670C), building scale (670D), or neighborhood scale (670E). Other common scene variations may be created using a combination of the exemplary embodiments described above or other points of view, time, and design not specifically described above.

Generally, a sourced image (100) environmental map and a variation (100A) environmental map will have more commonality than variance. According to an embodiment, the environmental map of a sourced image (100) is compared to the environmental map of a variation (100A).

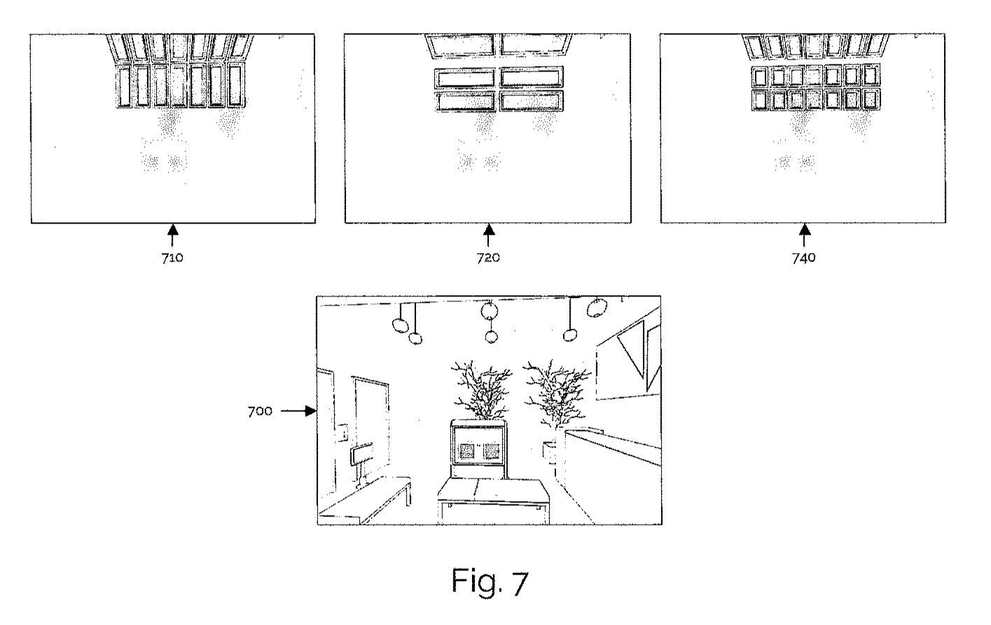

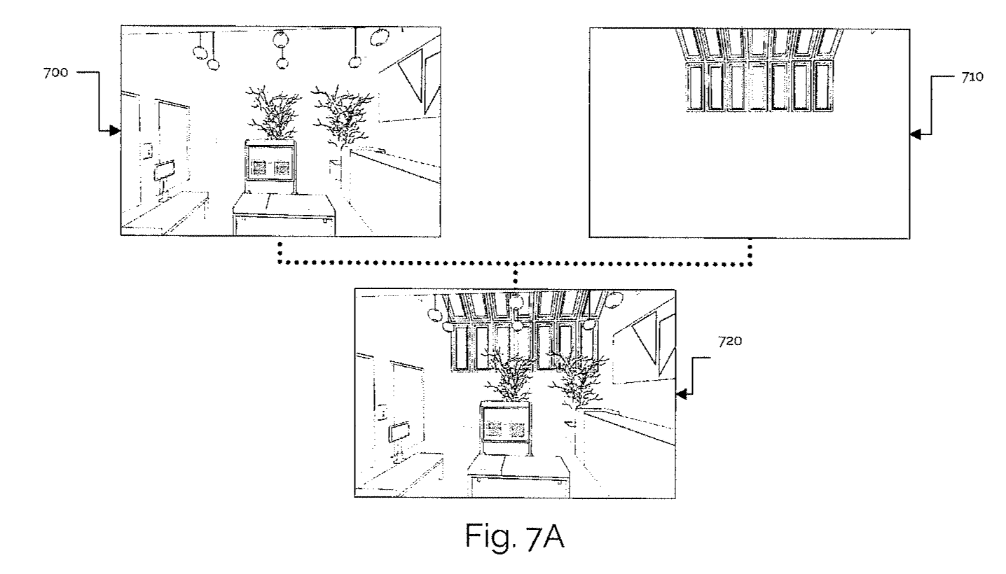

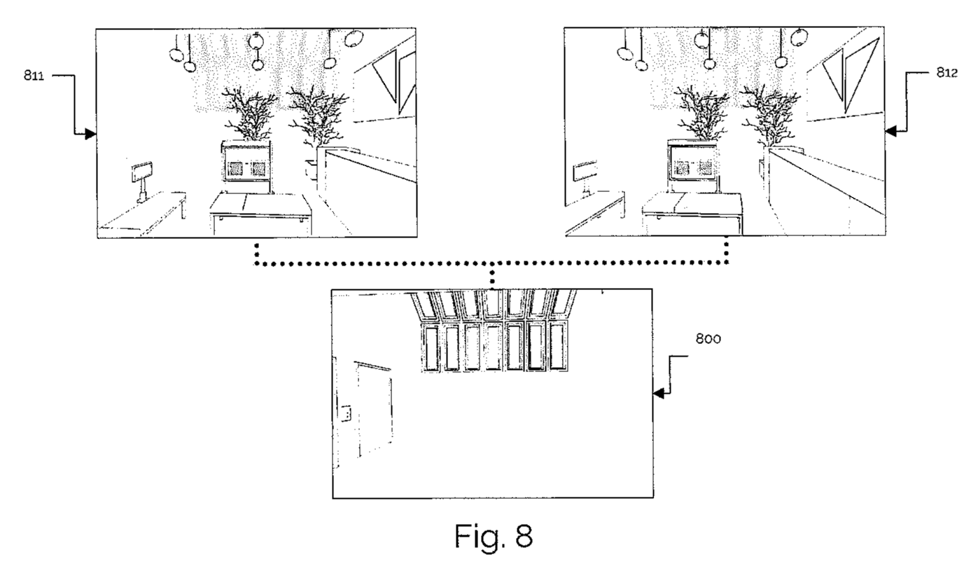

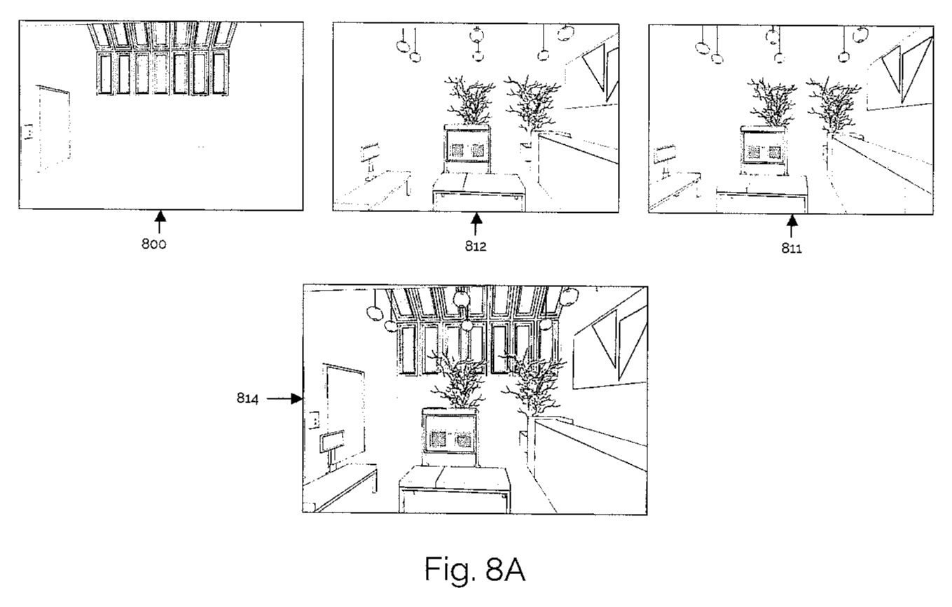

Referring to FIGS. 7 and 7A, according to an embodiment, equivalent or substantially equivalent pixels of a sourced image (100) environmental map and variation (100A) environmental map maybe calculated. According to an embodiment, equivalent or substantially equivalent pixels are extracted from the sourced image (100) and the variation (100A). According to an embodiment, the pixels of a sourced image (100) left after extraction are used to create a base layer image (700). According to an embodiment, the dissimilar pixels of the sourced image (100) and the variation (100A) environmental map are extracted to create at least one overlay image (710, 720, 740).

According to an embodiment, publishing means delivering, to at least one mobile device or web based platform, at least one sourced image (100), semantic scene (100A), and/or variation (100A). According to an embodiment, publishing means delivering, to at least one mobile device or web based platform, at least one base layer image (700) and/or at least one overlay image (710).

Referring to FIGS. 1, 1C, and 1D, according to an embodiment, a semantic scene (300) is created by assigning at least a description (131), teleporter (134), hotspot (135), annotation or a combination thereof to at least one sourced image (100).

According to an embodiment, at least one additional sourced image (100) or variation (100A) may be used to create at least a second semantic scene (300) (133). According to an embodiment, a definitional relationship may be provided by a hotspot (41). According to an embodiment, the relationship of the additional sourced image (100) to at least one sourced image (100) may be defined by a variation, point of view, vantage point, overlay, and/or spatial connections, or other connections that a publisher may want to define (134). Spatial connections may include at least two points in the same room, same building, same city, same country, for example. According to an embodiment, navigation from sourced image (100) to at least one additional sourced image is defined by at least one assigned location teleporter (43) (134).

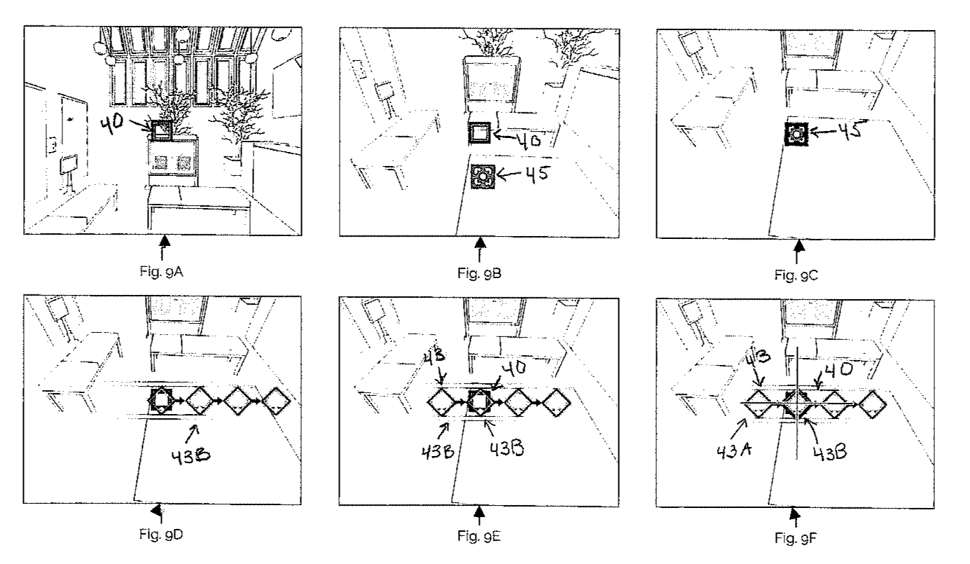

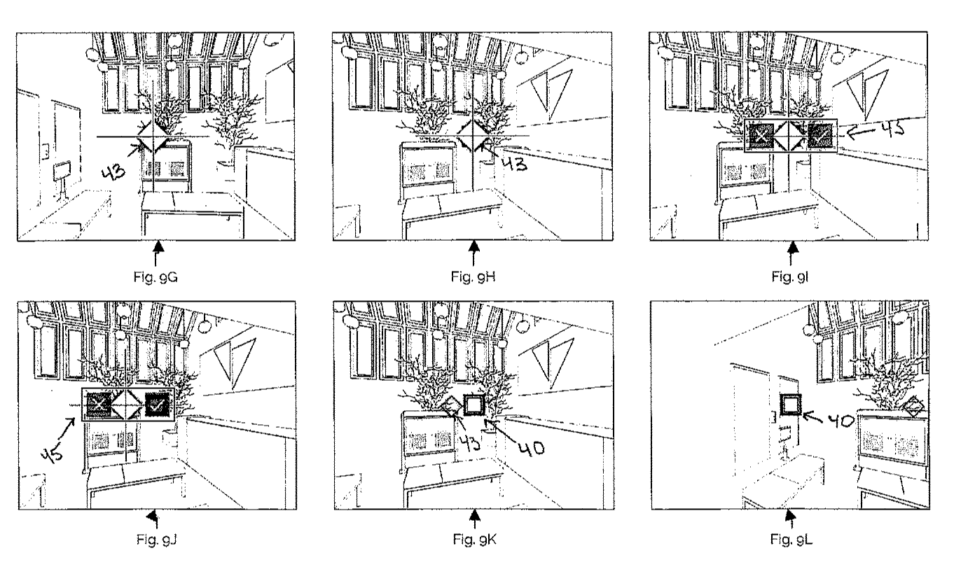

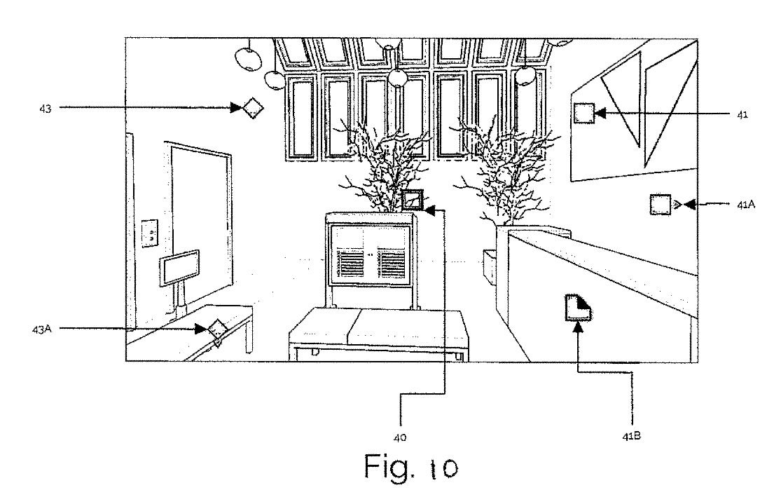

Referring to FIGS. 9A through 9L, an exemplary process of assigning a teleporter (43) in an interactive immersive environment is shown. FIG. 9A may be a sourced image (100) or a semantic scene (300) viewed in a VAR immersive environment. Reticle (40) is available to allow a user to interact with an overlay menu (45). Referring to FIGS. 9B and 9C, a user may gaze to move the reticle (40) to hover over menu (45). Referring to FIG. 9D, hovering over a menu (45) may cause a list of teleporters (43B) to appear. A teleporter (43) is linked to a different location within the sourced image (100) or semantic scene (300), or a teleporter (43) may be linked to a different sourced image (100) or semantic scene (300). Referring to FIG. 9E, a user can move from a first teleporter (43) to another teleporter (43A) in a list of teleporters (43B) by moving his gaze. Referring to FIG. 9F, the user may select a teleporter (43) by focusing his gaze, for a predetermined period, over the selected teleporter (43). Referring to FIG. 9G and FIG. 9H, the user may move his gaze to attach the reticle (40) to the selected teleporter (43). For example, the user may move his gaze in the upward direction or to the right. Referring to FIG. 9I, when the user pauses his gaze, at least one menu option (45) may appear. For example, the option, as shown in FIG. 91, is the acknowledgement that gaze location is where a selected teleporter (43) should be fixed. Referring to FIG. 9J, the user would focus his gaze over the menu option (45) for a pre-determined period to confirm the menu option (45). Referring to FIG. 9L, the selected teleporter (43) is fixed in sourced image (100) or semantic scene (300).

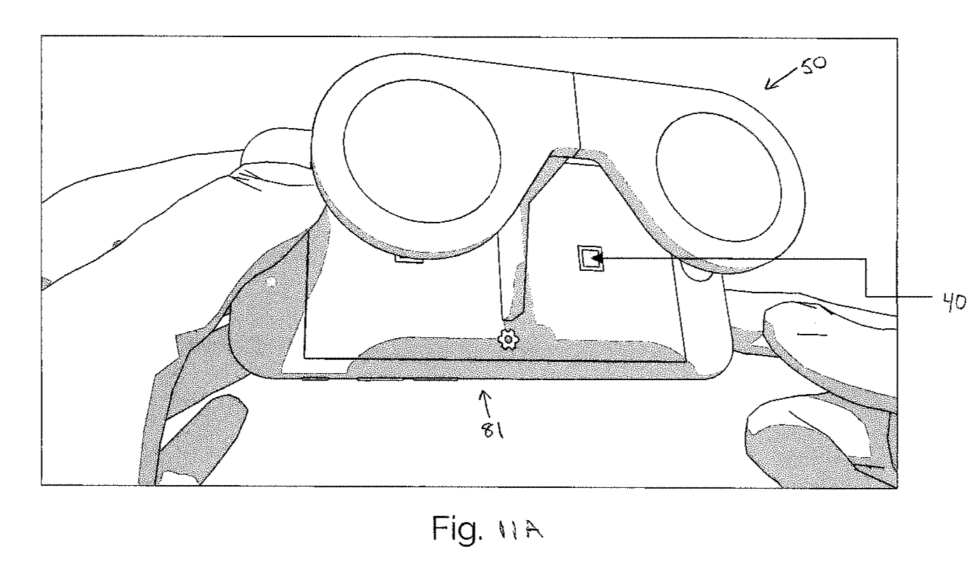

Referring to FIG. 10, according to an embodiment, the appearance of a hotspot (41) may be symbolized to distinguish a hotspot (41) that has not been visited, is off-screen or out of view (41A), or has been visited (41B). According to an embodiment, the appearance of a teleporter (43) may be symbolized to distinguish a teleporter (43) that has not yet been activated, is off-screen or out of view, and may take the user to a second location.

Referring to FIG. 1D, according to an embodiment, a publisher may annotate at least one sourced image (100) and/or variation (100A) (135). According to an embodiment, more than one publisher may annotate a sourced image (100) and/or a variation (100A) asynchronously or synchronously (135).

Referring to FIGS. 1 and 1D, according to an embodiment, publishing means delivering at least one semantic scene (300) and/or sourced image (100) to at least one mobile device, web based platform, or dedicated VAR device. According to an embodiment, publishing means delivering at least one semantic scene (300) to at least one mobile device and/or web based platform or dedicated VAR device.

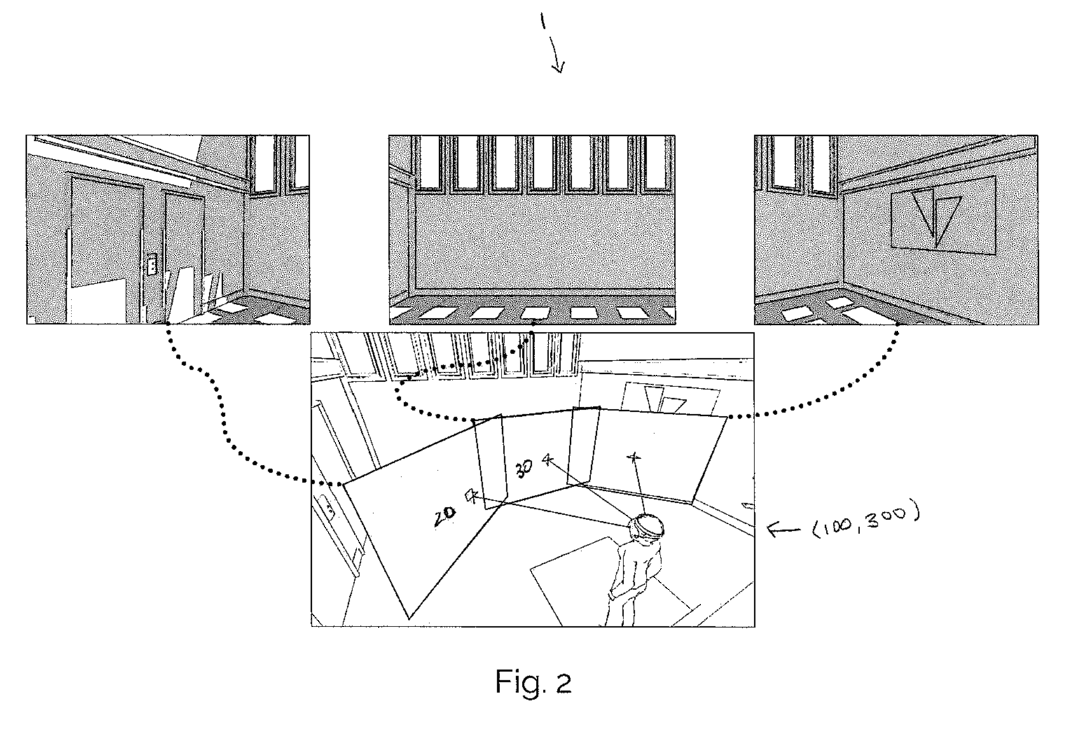

Referring to FIGS. 1, 1A, 1B, and 2, according to an embodiment, annotation means recording or tracking a user's changing attention through at least one sourced image (100) or semantic scene (300). A user's changing attention (1) is recorded or tracked from a starting focus area (20) to at least a second focus area (30) within a sourced image (100) or semantic scene (300). According to one embodiment, a user's focus area (20) is determined by head position and/or eye gaze. According to an embodiment, annotation is voice annotation from a starting focus area (20) through at least a second focus area (30). According to an embodiment, annotation is a user's changing attention coordinated with voice annotation through the same starting focus area (20) through at least a second focus area (30) in the same sourced image (100) or semantic scene (300).

According to an embodiment, annotation means recording or tracking a user's attention at a focus area (20) within a sourced image (100) of semantic scene (300). According to one embodiment, a user's focus area (30) is determined by head position and/or eye gaze. According to an embodiment, annotation is voice annotation to at least one focus area (20). According to an embodiment, annotation is a user's attention coordinated with voice annotation through the same starting focus area (20) in the same sourced image (100) or semantic scene (300).

Referring to FIGS. 1, 1E, 2, 11A, and 11B, according to an embodiment, annotation maybe shown by a reticle (40) or a visual highlight path or drawn region (80), a heat map, wire frame, or other visual representation of a data set that that relates to the underlying sourced image (100) or semantic scene (300) According to an embodiment, navigation of more than one user through the same sourced image (100) or semantic scene (300) is shown by separate and distinctive reticles (40). According to an embodiment, each separate and distinctive reticle (40) may be shown as a different color, shape, size, icon, text, etc.

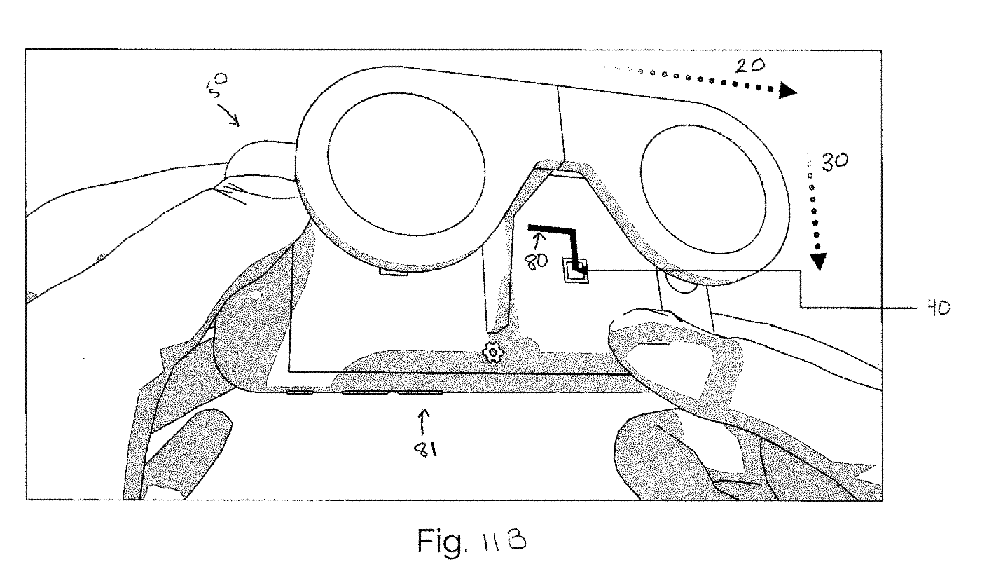

Referring to FIGS. 1, 1E, 1A and 11B, according to an embodiment, a user may draw a visual highlight path or region (80) on a computing device screen that is also an input device (“touch screen”) (81). According to an embodiment, to draw a visual highlight path or region (80) a user may target attention to a focus area (20) (82), communicate with the touch screen of a computing device (83), and change attention to at least a second focus area (30) (84). According to an embodiment, a visual highlight path or region (80) may fade away when the user no longer communicates with the touch screen (81) (85). According to an embodiment, a visual highlight path or region (80) may be viewed by each user in a meeting (12). According to an embodiment, a user may draw a visual highlight path or region (80) that can be viewed at a time after a meeting or asynchronously (510).

According to an embodiment, more than one user may view a semantic scene (300) or sourced image (100) synchronously on the same immersive or non-immersive application (2). According to an embodiment, a pre-determined user (or presenter) may control interaction of at least one other user through at least one semantic scene (300) or sourced image (100) when the presenter and user are viewing the scene synchronously. According to an embodiment, a reticle (40) representing a presenter's gaze may be visible when users are synchronously viewing a published semantic scene (300) or a sourced image (100). According to an embodiment, a presenter may guide teleportation when the presenter and at least one other user are viewing a semantic scene (300) or sourced image (100) synchronously.

According to an embodiment, more than one user may view a semantic scene (300) or sourced image (100) asynchronously (2). According to an embodiment, more than one user may view a semantic scene (300) or sourced image (100) asynchronously on a mobile platform, a dedicated VAR platform (2). According to an embodiment, more than one participant may annotate a semantic scene (300) or sourced image (100) asynchronously (5). According to an embodiment, more than one participant may view a semantic scene (300) or sourced image (100) synchronously (2) but may annotate the semantic scene (300) or sourced image (100) asynchronously (5). According to an embodiment, at least one user may join or leave a synchronous meeting (12).

Referring to FIG. 2, according to an embodiment, a user's movement throughout a VAR immersive environment is shown by a reticle (40). According to an embodiment, each distinctive visible reticle (40) may be shown as a different color, shape, size, icon, animation, etc.

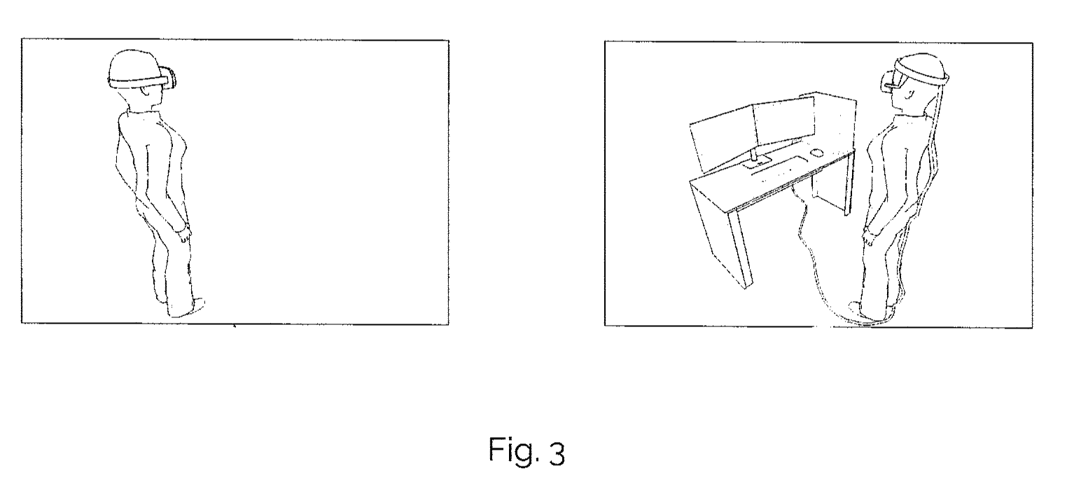

Referring to FIGS. 3, 11A, 11B, according to an embodiment, a user may view the VAR immersive environment on a mobile computing device (50), such as a smart phone or tablet. (2) According to an embodiment, the user may view the VAR immersive environment using any attachable binocular optical system such as Google Cardboard, or with dedicated hardware such as Oculus Rift or HTC Vive, or other similar devices.

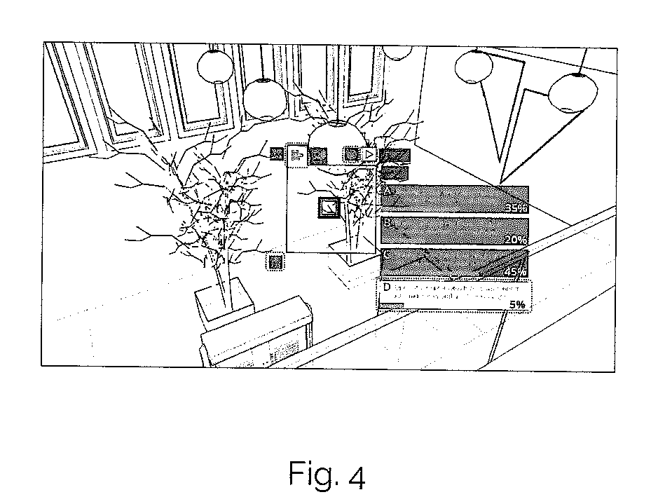

Referring to FIGS. 1, 1A, 1B and 3, according to an embodiment, a user may select a hotspot (41) that affects the VAR immersive environment. According to an embodiment, selecting a hotspot (41) may include selecting at least one attribute from a plurality of attributes (11). According to an embodiment, selected attributes maybe represented graphically (60). FIG. 4 shows an exemplary graphical presentation. As will be appreciated by one having skill in the art, a graphical representation may be embodied in numerous designs.

According to an embodiment, the publisher may survey at least one user regarding a published a semantic scene (300) or sourced image (100). According to an embodiment, survey results may be graphically or numerically represented within the VAR immersive environment. (14)

According to an embodiment, more than one user may synchronously interact with at least one a semantic scene (300) or sourced image (100) (8). According to an embodiment, more than one user may choose one out of a plurality of semantic scenes (300) or sourced images (100) with which to interact (8). According to an embodiment, each of the plurality of users may choose to interact with a different semantic scene (300) or sourced image (100) from a plurality of semantic scenes (300) or sourced images (100) (8). According to an embodiment, at least one of the more than one users may join or leave a synchronous meeting (12).

Referring to FIGS. 1 and 5, according to an embodiment, a meeting (12) may be recorded for later playback. According to an embodiment, meetings (520) may be auto-summarized in real-time or at the conclusion of a meeting. According to an embodiment, summarization means using known artificial intelligence techniques to create a shorter or compact version of a meeting. According to an embodiment, summarization may be tailored to a viewer. For example, a recorded meeting may be summarized according to time, a bulleted text list of important points, a cartoon that represents the flow of the meeting, an infographic topic, decisions, and/or tasks, or a first-person participant abstract, amongst others.

According to an embodiment, advertisement, or other content maybe embedded in a recorded meeting (530). According to an embodiment, advertisement or other content may be overlaid on to a recorded meeting. According to an embodiment, advertisement or other content may precede a meeting. According to an embodiment, advertisement or other content may be attached to a meeting.

According to an embodiment, at least one user may view a recorded meeting (530) in an immersive environment. According to an embodiment, at least one user may select a time on a recorded meeting (530) to start or end viewing. According to an embodiment, at least one user may move from a first selected time to at least a second selected time at a selected speed. For example, a user may “fast forward” to a selected time.

As will be appreciated by one skilled in the art, aspects of the present invention may be embodied as a system, method, or computer product. Accordingly, aspects of the present invention may take the form of an entirely hardware embodiment, entirely software embodiment (including firmware, resident software, micro-code, etc.), or an embodiment combining software and hardware aspects. Further aspects of this invention may take the form of a computer program embodied in one or more readable medium having computer readable program code/instructions thereon. Program code embodied on computer-readable medium may be transmitted using any appropriate medium, including but not limited to wireless, wireline, optical fiber cable, RF, etc., or any suitable combination of the foregoing. The computer code may be executed entirely on a user's computer, partly on the user's computer, as a standalone software package, a cloud service, partly on the user's computer and partly on a remote computer or entirely on a remote computer, remote or cloud based server.

We claim as our invention:

1. A system for simplifying VAR based communication and collaboration that enhances decision making allowing a plurality of users to collaborate on multiple-dimension data sets through a streamlined user interface framework that enables both synchronous and asynchronous interactions in immersive environments comprising:
(a) a user interface configured to:
(i) create an augmented reality or virtual augmented reality environment over an immersive environment;
(ii) annotate the augmented reality or virtuat augmented reality environment;
(iii) publish an augmented reality or virtual augmented reality environment over an immersive environment;
(b) the user interface is deployed on mobile device or on tethered or untethered dedicated VAR hardware.

2. The system according to claim l wherein, creating an augmented reality or virtual augmented reality environment over an immersive environment is comprised of:
(a) sourcing at least one image wherein the sourced image represents a three-dimensional environment or data-set.
(b) creating of at least one semantic scene.

3. The system according to claim 2 wherein, creating of at least one semantic scene is comprised of layering a sourced image with at least one description, teleporter, hotspot, annotation or combination thereof.

4. The system according to claim 3 wherein, layering a sourced image with a teleporter is further comprised of enabling a user to choose one teleporter from a plurality of teleporters using gaze in an immersive environment.

5. The system according to claim 4 wherein, layering a sourced image with a teleporter is further comprised of enabling a user to assign a chosen teleporter to a location by holding a gaze.

6. The system according to claim 5 wherein, layering a sourced image with a teleporter is further comprised of enabling a user to verify the location of an assigned teleporter by moving user gaze from a first focus area to a second focus area.

7. The system according to claim I wherein, sourcing at least one image is comprised of extracting the same or similar portions of more than one sourced image to create a base layer and overlay.

8. The system according to claim 7 wherein, publishing an augmented reality or virtual augmented reality environment over an immersive environment means delivering of a base layer and overlay to a mobile device, web platform, and/or dedicated augmented reality or virtual augmented reality device.

9. The system according to claim 8 wherein, publishing an augmented reality or virtual augmented reality environment over an immersive environment means delivering a sourced image or semantic scene to a mobile device, web platform, and/or dedicated augmented reality or virtual augmented reality device

10. The system according to claim 1 wherein, annotating an augmented reality or virtual augmented reality environment is comprised of:
(a) tracking or recording a user's head position and/or focus or eye gaze from a starting focus area through at least a second focus area in the immersive environment;
(b) recording a user's voice from a starting focus area through at least a second focus area; or
(c) a combination thereof.

11. The system according to claim 16 wherein, annotation in the immersive environment is represented by a reticle or visual channel; were the visual channel is a visual highlight path or region, heat map, a wire frame, or a combination thereof.

12. The system according to claim 11 wherein, a user draws the visual highlight path or region by:
(a) targeting attention to a focus area;
(b) communicate with the mobile device or tethered or untethered dedicated VAR hardware;
(c) change attention to a second focus area.

13. The system according to claim 12 wherein, the visual highlight path or region fades or disappears when the user stops communicating with the mobile device or tethered or untethered dedicated VAR hardware.

14. The system according to claim 6 is further comprised of enabling more than one user to synchronously or asynchronously interact with the annotated immersive environment.

15. The system according to claim 14 is further comprised of enabling user, or presenter, to guide interaction of at least one other user through at least one semantic scene or sourced image when the presenter and user are viewing the semantic scene or sourced image synchronously in an immersive environment.

16. The system according to claim 15 wherein to control interaction means the presenter guides teleportation

17. The system according to claim 16 is further comprised of enabling more than one user to synchronously or asynchronously annotate a semantic scene or sourced image in an immersive environment

18. The system according to claim 17 is further comprised of recording more than one user synchronously interacting on an immersive environment for later playback in an immersive environment.

19. The system according to claim 18 is further comprised of auto-summarizing the recording.

20. The system according to claim 19 is further comprised of allowing intelligent playback of the recording.
